(19) United States
(12) Patent Application Publication
(10) Pub. No.: US 2018/0189656 A1
(43) Pub. Date: Jul. 5, 2018

(54) Managing Questions

(71) Applicant: International Business Machines Corporation, Armonk, NY (US)

(72) Inventors: Caroline Church, Andover (GB); Mark P. Frost, Eastleigh (GB); Allan C. Hurworth, Southampton (GB); Dominic J. Storey, Eastleigh (GB)

(21) Appl. No.: 15/399,045

(22) Filed: Jan. 5, 2017

(51) Int. Cl. G06N 5/02; G06N 99/00

(52) U.S. Cl. CPC G06N 5/022; G06N 99/005

(57) ABSTRACT

Managing questions is provided. A question is sent to a subject matter expert corresponding to a selected subject matter expert class via a network. A response is received from the subject matter expert via the network indicating whether the subject matter expert is able to answer the question. It is determined whether the response indicates that the subject matter expert is able to answer the question. In response to determining that the response indicates that the subject matter expert is able to answer the question, a state of a data structure corresponding to the selected subject matter expert class is transformed by adding text of the question to the selected subject matter expert class.

### BACKGROUND

### 1. Field

The disclosure relates generally to managing questions and more specifically to managing questions provided to an expert system that require subject matter expert review.

### 2. Description of the Related Art

In artificial intelligence, an expert system is a computer component that emulates the decision-making ability of a human expert. Expert systems are designed to solve complex problems by reasoning about knowledge, represented primarily as if-then rules rather than through conventional procedural code. Typically, an expert system is divided into two sub-systems, such as, for example, an inference engine and a knowledge base. The knowledge base represents facts and rules. The inference engine applies the rules to the known facts to deduce new facts.

When training an expert system, a training cycle process is followed. The training cycle includes a process where each question being asked of the expert system is checked by a subject matter expert to see if the expert system's answer to a question was right or wrong. A subject matter expert is a person who is an authority in a particular area or topic. This process accumulates correct training data, which can be used to train another instance that will benefit from this training. This training cycle process continues building up the expert system's confidence in answering questions.

### SUMMARY

According to one illustrative embodiment, a computer-implemented method for managing questions is provided. A computer sends a question to a subject matter expert corresponding to a selected subject matter expert class via a network. The computer receives a response from the subject matter expert via the network indicating whether the subject matter expert is able to answer the question. The computer determines whether the response indicates that the subject matter expert is able to answer the question. In response to the computer determining that the response does indicate that the subject matter expert is able to answer the question, the computer transforms a state of a data structure corresponding to the selected subject matter expert class by adding text of the question to the selected subject matter expert class. According to other illustrative embodiments, a computer system and computer program product for managing questions are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a question management system in accordance with an illustrative embodiment;

FIG. 4 is an example of a database data structure in accordance with an illustrative embodiment; and

FIGS. 5A-5B are a flowchart illustrating a process for managing questions in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

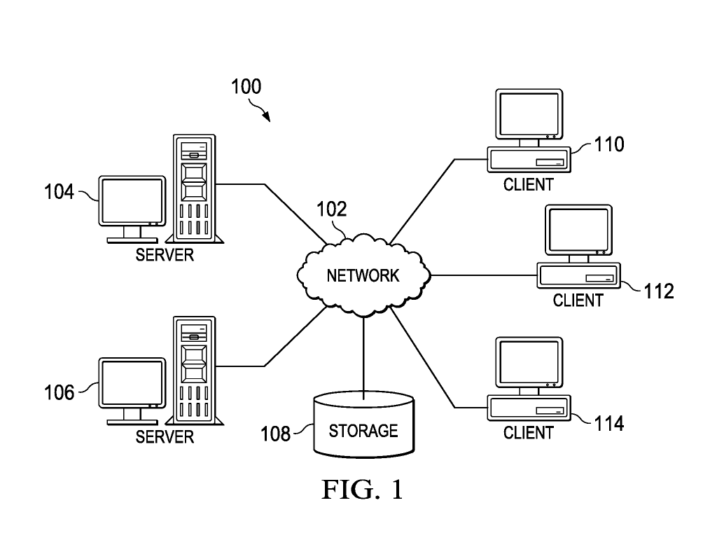

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide a set of services for managing questions provided to expert systems that may require subject matter expert review. Also, it should be noted that server 104 and server 106 may each represent a plurality of different servers providing a plurality of different question management services.

Client 110, client 112, and client 114 also connect to network 102. Clients 110, 112, and 114 are clients of server 104 and server 106. Further, server 104 and server 106 may provide information, such as software applications and programs to clients 110, 112, and 114.

In this example, clients 110, 112, and 114 are illustrated as desktop or personal computers with wire or wireless communication links to network 102. However, it should be noted that clients 110, 112, and 114 are meant as examples only. In other words, clients 110, 112, and 114 may include other types of data processing systems, such as, for example, network computers, laptop computers, handheld computers, smart phones, smart watches, personal digital assistants, and the like, with wire or wireless communication links to network 102. Users of clients 110, 112, and 114 may utilize clients 110, 112, and 114 to send questions to and receive questions from server 104 and server 106.

For example, client 110 may correspond to a question submitter. It should be noted that client 110 may represent a plurality of different client devices corresponding to a plurality of different question submitters connected to network 102. A question submitter is a person who presents a question to server 104 or server 106 for an answer. In response to server 104 or server 106 receiving a question, the server determines whether the server can answer the question with a confidence level above a defined confidence level threshold. If the server is able to answer the question with a confidence level greater than the defined confidence level threshold, then the server sends an answer to the question to client 110 for review by the question submitter. After reviewing the answer to the question provided by the server, the question submitter may send a response to the server indicating whether the answer was acceptable or not.

If the response from the question submitter indicates that the answer was not acceptable or if the server could not answer the question with a confidence level greater than the defined confidence level threshold, then the server may send the question to a subject matter expert corresponding to client 112 or client 114. The server may send the question to a particular subject matter expert based on the server calculating a confidence score for each subject matter expert corresponding to client 112 and client 114 and then selecting the subject matter expert with a highest calculated confidence score to route the question to. The server may calculate the confidence score for each respective subject matter expert based on same or similar questions having been previously associated with a particular subject matter expert in a database, such as storage 108. Further, the selected subject matter expert receiving the question may send a response to the server indicating whether the selected subject matter expert is able to answer the question. If the response indicates that the selected subject matter expert is able to answer the question, then the server updates the database by associating the question with the name of the selected subject matter expert for future reference. It should be noted that client 112 and client 114 may each represent a plurality of different client devices corresponding to a plurality of different subject matter experts connected to network 102.

Storage 108 is a network storage device capable of storing any type of data in a structured format or an unstructured format. In addition, storage 108 may represent a set of one or more network storage devices. Storage 108 may store, for example, names and identification numbers for a plurality of different question submitters; names and identification numbers for a plurality of different subject matter experts; subject matter expert profiles; histories of questions answered by respective subject matter experts; and the like. Further, storage 108 may store other data, such as authentication or credential data that may include user names, passwords, and biometric data associated with the question submitters, subject matter experts, and system administrators, for example.

In addition, it should be noted that network data processing system 100 may include any number of additional server devices, client devices, and other devices not shown. Program code located in network data processing system 100 may be stored on a computer readable storage medium and downloaded to a computer or data processing system for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), or any combination thereof. FIG. 1 is intended as an example, and not as an architectural limitation for the different illustrative embodiments.

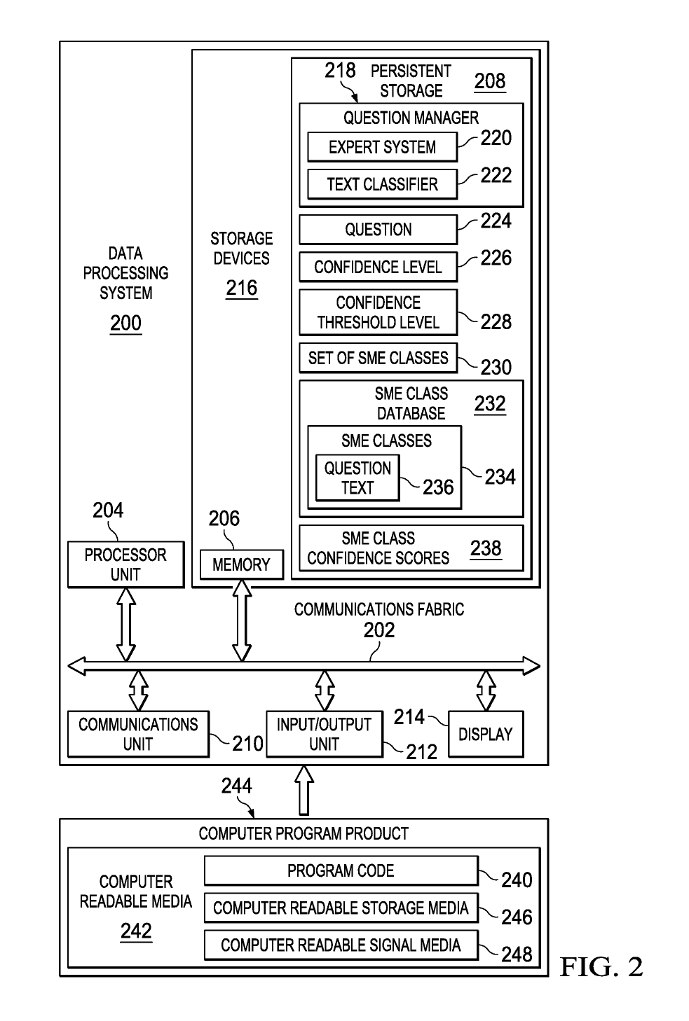

With reference now to FIG. 2, a diagram of a data processing system is depicted in accordance with an illustrative embodiment. Data processing system 200 is an example of a computer, such as server 104 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores question manager 218. Question manager 218 manages questions received from users of client devices that may require review by subject matter experts. It should be noted that even though question manager 218 is illustrated as residing in persistent storage 208, in an alternative illustrative embodiment question manager 218 may be a separate component of data processing system 200. For example, question manager 218 may be a hardware component coupled to communication fabric 202 or a combination of hardware and software components. In another alternative illustrative embodiment, a first set of components of question manager 218 may be located in data processing system 200 and a second set of components of question manager 218 may be located in a second server device, such as server 106 in FIG. 1.

In this example, question manager 218 includes expert system 220 and text classifier 222. Question manager 218 utilizes expert system 220 to provide an answer to question 224, which was submitted to data processing system 200 by a client device user. However, it should be noted that question 224 may represent a plurality of different questions submitted by a plurality of different client device users. In addition, question 224 may represent any type of question.

After receiving question 224, expert system 220 determines whether expert system 220 can answer question 224 with a confidence level, such as confidence level 226, greater than confidence threshold level 228. Confidence level 226 represents a degree of certainty that expert system 220 can answer the question correctly. For example, if expert system 220 has a high degree of certainty of answering question 224 correctly based information in a knowledge base corresponding to question 224 and/or correctly answering same or similar questions previously, then expert system 220 calculates confidence level 226 with a higher value. Conversely, if expert system 220 has a low degree of certainty of answering question 224 correctly, then expert system 220 calculates confidence level 226 with a lower value.

After calculating confidence level 226 for answering question 224, expert system 220 compares confidence level 226 to confidence threshold level 228. Confidence threshold level 228 represents a minimum threshold value for accepting an answer to question 224. For example, if expert system 220 determines that confidence level 226 is greater than confidence threshold level 228, then expert system 220 accepts the answer to question 224 and sends the answer to the client device user that submitted the question. Conversely, if expert system 220 determines that confidence level 226 is less than or equal to confidence threshold level 228, then expert system 220 rejects the answer to question 224 and sends question 224 to text classifier 222.

Text classifier 222 interprets and classifies natural language with associated confidence scores using natural language processing and machine learning, for example. In addition, text classifier 222 matches classes to texts. In this case, the classes are names of subject matter experts and the texts are the textual content of questions that a particular subject matter expert is able to answer. In other words, text classifier 222 returns the best matching class (i.e., subject matter expert name) for a question. For example, a client device user submits a question to data processing system 200 and text classifier 222 returns the name of the best matching subject matter expert to answer the question. Text classifier 222 learns from training data.

After text classifier 222 analyzes question 224, text classifier 222 returns a set of one or more subject matter expert (SME) classes, such as set of SME classes 230, corresponding to one or more subject matter experts. Text classifier 222 selects set of SME classes 230 from SME class database 232. SME class database 232 stores SME classes 234. SME classes 234 are a plurality of names corresponding to a plurality of subject matter experts. Each respective class in SME classes 234 includes question text 236. Question text 236 represents the textual content of questions that each particular subject matter expert is able to answer. Further, text classifier 222 calculates a confidence score for each respective subject matter class in set of SMD classes 230 forming SME class confidence scores 238. Text classifier 222 calculates SME class confidence scores 238 based on question text 236 associated with different SME classes 234. Furthermore, text classifier 222 may select the SME class in set of SME classes 230 having the highest calculated confidence score in SME class confidence scores 238 corresponding to set of SME classes 230. Moreover, text classifier 222 sends question 224 to the subject matter expert corresponding to the SME class having the highest calculated confidence score.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (WiFi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 218, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 240 is located in a functional form on computer readable media 242 that is selectively removable and may be loaded onto or transferred to data processing system 200 for running by processor unit 204. Program code 240 and computer readable media 242 form computer program product 244. In one example, computer readable media 242 may be computer readable storage media 246 or computer readable signal media 248. Computer readable storage media 246 may include, for example, an optical or magnetic disc that is inserted or placed into a drive or other device that is part of persistent storage 208 for transfer onto a storage device, such as a hard drive, that is part of persistent storage 208. Computer readable storage media 246 also may take the form of a persistent storage, such as a hard drive, a thumb drive, or a flash memory that is connected to data processing system 200. In some instances, computer readable storage media 246 may not be removable from data processing system 200.

Alternatively, program code 240 may be transferred to data processing system 200 using computer readable signal media 248. Computer readable signal media 248 may be, for example, a propagated data signal containing program code 240. For example, computer readable signal media 248 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 240 may be downloaded over a network to persistent storage 208 from another device or data processing system through computer readable signal media 248 for use within data processing system 200. For instance, program code stored in a computer readable storage media in a data processing system may be downloaded over a network from the data processing system to data processing system 200. The data processing system providing program code 240 may be a server computer, a client computer, or some other device capable of storing and transmitting program code 240.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 246 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

There are a large number of subject matter experts that can be assigned to checking answers provided by an expert system to questions. However, deciding which subject matter expert to ask a training question for the expert system may be a problem. Typically, a question is given to a subject matter expert and the subject matter expert is asked if the subject matter expert can answer the question or not. This process can take a long time to find the correct subject matter expert to ask.

For example, tasks are created to decide which answers to questions need reviewing by subject matter experts, at least those answers given a low confidence level by the expert system. Then, these tasks are randomly assigned to the different subject matter experts without any effective targeting mechanism. This in itself may lead to incorrect reviews and is a time consuming process.

Rather than classifying using field of specialty, such as, for example, history, art, or science, illustrative embodiments utilize names of subject matter experts as classes. For example, illustrative embodiments may route the question “When was the battle of Hastings?” to a particular subject matter expert based on the text classifier's confidence level in that particular subject matter expert's ability to answer the question correctly. That particular subject matter expert may then respond with an indication of the subject matter expert's ability to answer the question, which in turn updates the text classifier's training data.

The database data structure still holds the subject matter expert's profile information, but the class is the subject matter expert's name. Initially, the training data may be minimal and so the text classifier may have a low confidence level in selecting the correct subject matter expert to route a question to. However, over time this confidence level will increase as the amount of training data increases.

In other words, the text classifier interprets the intent behind text of a question and returns a corresponding class (i.e., name of a subject matter expert) with an associated confidence score. Illustrative embodiments may utilize the confidence score to trigger an action, such as routing the question to the associated subject matter expert. Thus, illustrative embodiments utilize the subject matter expert's name as the class and associate all questions that the subject matter expert can answer with that class. Then, the text classifier may use this training data to match a question to a subject matter expert who can answer that question.

Illustrative embodiments transform a state of a data structure of the training data in response to illustrative embodiments updating the training data when a subject matter expert with a high confidence score can answer a question with certainty. Updating the class corresponding to the subject matter expert includes adding the text of the question to the class. Further, illustrative embodiments add additional questions to the class as the subject matter expert answers more questions building up the training data.

Illustrative embodiments by deciding which subject matter expert to send a question to for confirmation decrease the subject matter expert selection feedback process. Thus, illustrative embodiments increase the quality of answers to questions and decrease the turnaround time for the expert system training cycle. Furthermore, illustrative embodiments improve the performance of the computer, itself, by providing the computer with the capability to make better selections and decrease processing time by utilizing the name of a subject matter expert as the class and storing question text with the class.

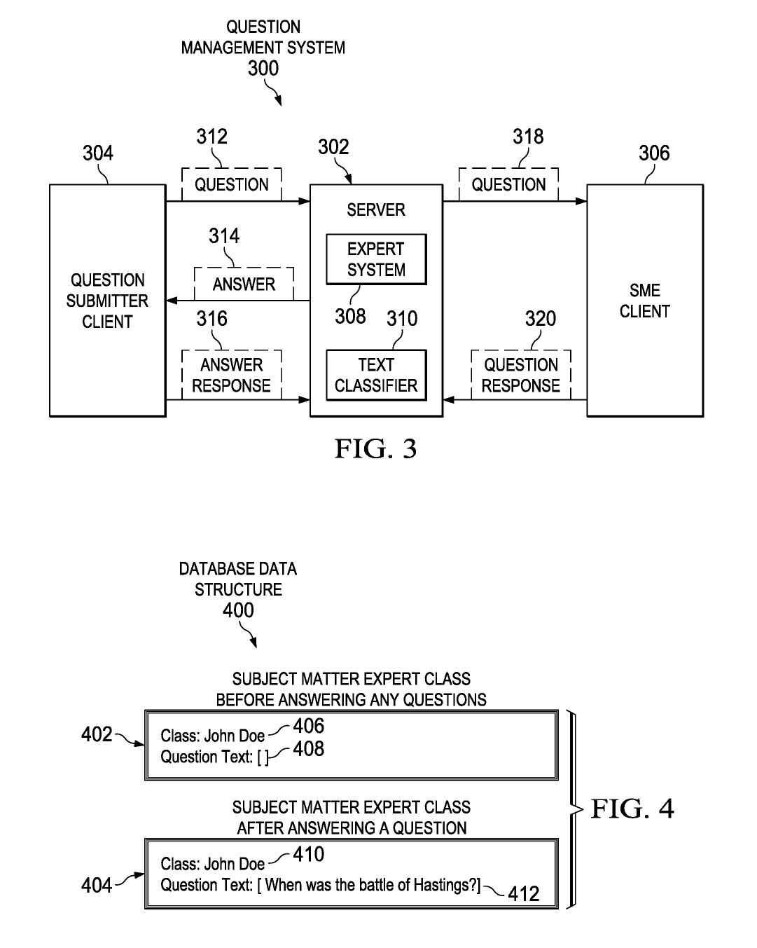

With reference now to FIG. 3, a diagram illustrating an example of a question management system is depicted in accordance with an illustrative embodiment. Question management system 300 is a system of software and hardware components for managing questions provided to an expert system that may require subject matter expert review. Question management system 300 may be implemented in a network of data processing systems, such as network data processing system 100 in FIG. 1.

In this example, question management system 300 includes server 302, question submitter client 304, and subject matter expert client 306. However, it should be noted that question management system 300 is only meant as an example and not as a limitation on illustrative embodiments. In other words, question management system 300 may include any number of server and client devices.

Server 302 may be, for example, server 104 in FIG. 1 or data processing system 200 in FIG. 2. Also in this example, server 302 includes expert system 308 and text classifier 310, such as expert system 220 and text classifier 222 in FIG. 2. Server 302 receives question 312 from question submitter client 304. Question submitter client 304 represents a data processing system, such as client 110 in FIG. 1, which corresponds to a user who submits question 312 to server 302. Question 312 may be, for example, question 224 in FIG. 2, and may represent any type of question.

In response to receiving question 312, server 302 sends question 312 to expert system 308 for an answer, such as answer 314. If expert system 308 is able to answer question 312 with a confidence level greater than a confidence threshold level, then expert system 308 sends answer 314 to question submitter client 304. Subsequent to receiving answer 314, question submitter client 304 sends answer response 316 to server 302 indicating whether the user of question submitter client 304 finds answer 314 acceptable or not.

If answer response 316 indicates that answer 314 is not acceptable or if expert system 308 is not able to answer question 312 with a confidence level above the confidence threshold level, then server 302 sends question 312 to text classifier 310 for analysis. After analyzing question 312, text classifier 310 selects a subject matter expert class having a highest calculated confidence score that is based on questions, which are the same or similar to question 312, previously associated with the subject matter expert class. Subsequent to selecting the subject matter expert class, text classifier 310 sends question 318, which is the same as question 312, to subject matter client 306. Subject matter client 306 corresponds to the subject matter expert whose name is the selected subject matter expert class. Subsequently, subject matter expert client 306 sends question response 320 to server 302 indicating whether the subject matter expert is able to answer question 318. If question response 320 indicates that the subject matter expert is able to answer question 318, then text classifier 310 updates the subject matter expert class corresponding to the subject matter expert with the text of question 318.

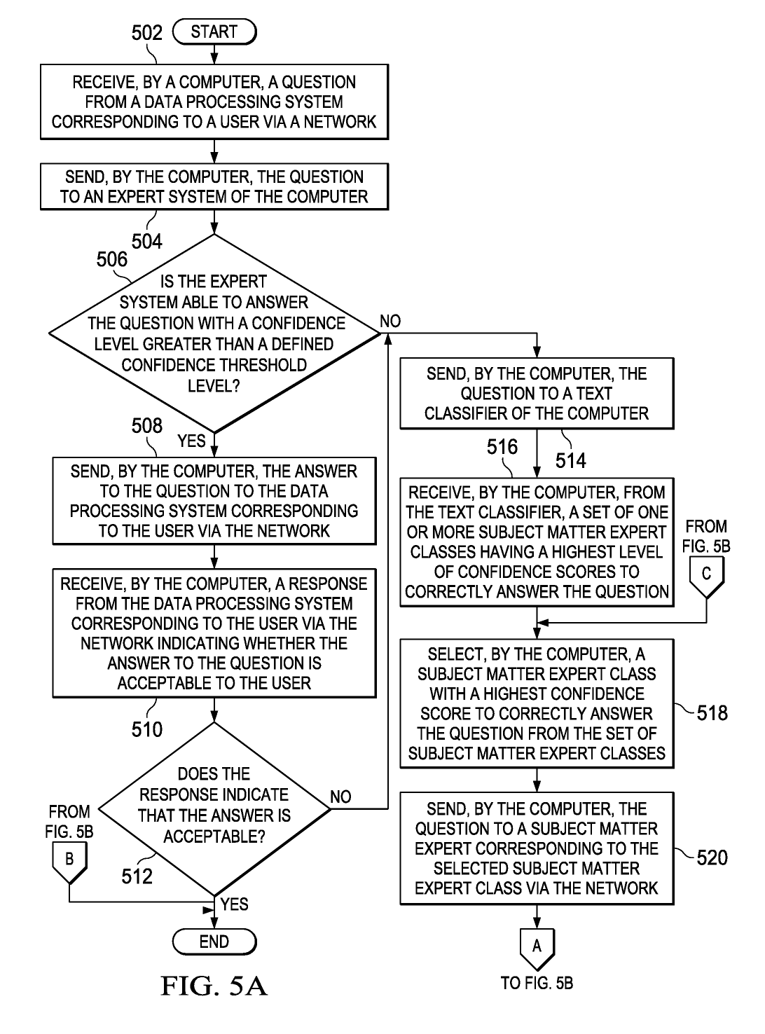

With reference now to FIG. 4, an example of a database data structure is depicted in accordance with an illustrative embodiment. Database data structure 400 represents a state of a database record corresponding to a subject matter expert. Database data structure 400 may be stored in a subject matter expert class database, such as SME class database 232 in FIG. 2.

State 402 represents a state of a subject matter expert class before answering any questions. State 404 represents a state of the subject matter expert class after answering a question. In this example, at state 402, subject matter class 406 is “John Doe” and question text 408 is a null or empty set because John Doe has not answered any questions up to this point in time. At state 404, subject matter class 410 is John Doe, which is the same as subject matter class 406. However, question text 412 is now “When was the battle of Hastings?”, which John Doe is able to answer correctly. In addition, it should be noted that as subject matter expert John Doe answers more questions, illustrative embodiments add these questions to question text 412.

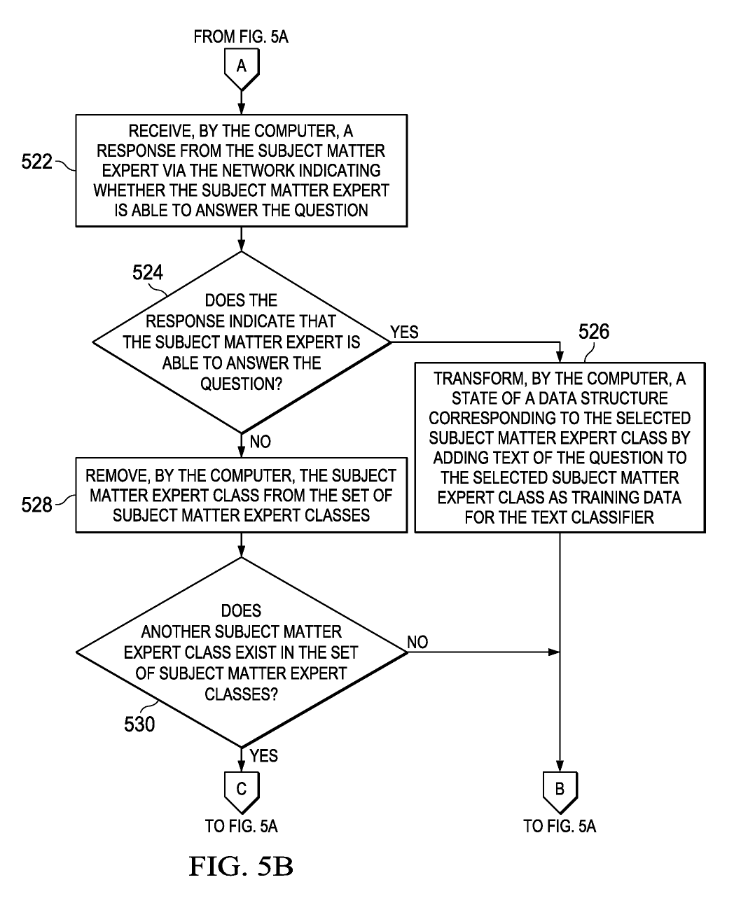

With reference now to FIGS. 5A-5B, a flowchart illustrating a process for managing questions is shown in accordance with an illustrative embodiment. The process shown in FIGS. 5A-5B may be implemented in a computer, such as, for example, server 104 in FIG. 1 or data processing system 200 in FIG. 2.

The process begins when the computer receives a question from a data processing system corresponding to a user via a network (step 502). In response to receiving the question in step 502, the computer sends the question to an expert system of the computer (step 504). Subsequently, the computer makes a determination as to whether the expert system is able to answer the question with a confidence level greater than a defined confidence threshold level (step 506).

If the computer determines that the expert system is not able to answer the question with a confidence level greater than the defined confidence threshold level, no output of step 506, then the process proceeds to step 514. If the computer determines that the expert system is able to answer the question with a confidence level greater than the defined confidence threshold level, yes output of step 506, then the computer sends the answer to the question to the data processing system corresponding to the user via the network (step 508). In addition, the computer receives a response from the data processing system corresponding to the user via the network indicating whether the answer to the question is acceptable to the user (step 510).

Afterward, the computer makes a determination as to whether the response indicates that the answer is acceptable (step 512). If the computer determines that the response does indicate that the answer is acceptable, yes output of step 512, then the process terminates thereafter. If the computer determines that the response indicates that the answer is unacceptable, no output of step 512, then the computer sends the question to a text classifier of the computer (step 514).

Subsequently, the computer receives from the text classifier a set of one or more subject matter expert classes having a highest level of confidence scores to correctly answer the question (step 516). Then, the computer selects a subject matter expert class with a highest confidence score to correctly answer the question from the set of subject matter expert classes (step 518). Further, the computer sends the question to a subject matter expert corresponding to the selected subject matter expert class via the network (step 520).

Furthermore, the computer receives a response from the subject matter expert via the network indicating whether the subject matter expert is able to answer the question (step 522). Afterward, the computer makes a determination as to whether the response indicates that the subject matter expert is able to answer the question (step 524). If the computer determines that the response does indicate that the subject matter expert is able to answer the question, yes output of step 524, then the computer transforms a state of a data structure corresponding to the selected subject matter expert class by adding text of the question to the selected subject matter expert class as training data for the text classifier (step 526) and the process terminates thereafter. If the computer determines that the response indicates that the subject matter expert is unable to answer the question, no output of step 524, then the computer removes the subject matter expert class from the set of subject matter expert classes (step 528).

Moreover, the computer makes a determination as to whether another subject matter expert class exists in the set of subject matter expert classes (step 530). If the computer determines that another subject matter expert class does not exist in the set of subject matter expert classes, no output of step 530, then the process terminates thereafter. If the computer determines that another subject matter expert class does exist in the set of subject matter expert classes, yes output of step 530, then the process returns to step 518 where the computer selects another subject matter expert class with a next highest confidence score from the set of subject matter expert classes.

Thus, illustrative embodiments of the present invention provide a computer-implemented method, computer system, and computer program product for managing questions provided to an expert system that may require subject matter expert review. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for managing questions, the computer-implemented method comprising:
sending, by a computer, a question to a subject matter expert corresponding to a selected subject matter expert class via a network;
receiving, by the computer, a response from the subject matter expert via the network indicating whether the subject matter expert is able to answer the question;
determining, by the computer, whether the response indicates that the subject matter expert is able to answer the question; and
responsive to the computer determining that the response does indicate that the subject matter expert is able to answer the question, transforming, by the computer, a state of a data structure corresponding to the selected subject matter expert class by adding text of the question to the selected subject matter expert class.

2. The computer-implemented method of claim 1 further comprising:
responsive to the computer determining that the response indicates that the subject matter expert is unable to answer the question, removing, by the computer, the selected subject matter expert class from a set of subject matter expert classes.

3. The computer-implemented method of claim 1 further comprising:
receiving, by the computer, the question from a data processing system corresponding to a user via the network;
sending, by the computer, the question to an expert system of the computer;
determining, by the computer, whether the expert system is able to answer the question with a confidence level greater than a defined confidence threshold level; and
responsive to the computer determining that the expert system is able to answer the question with a confidence level greater than the defined confidence threshold level, sending, by the computer, the answer to the question to the data processing system corresponding to the user via the network and receiving, by the computer, a response from the data processing system corresponding to the user via the network indicating whether the answer to the question is acceptable to the user.

4. The computer-implemented method of claim 3 further comprising:
responsive to the computer determining that the response indicates that the answer is unacceptable, sending, by the computer, the question to a text classifier of the computer.

5. The computer-implemented method of claim 3 further comprising:
responsive to the computer determining that the expert system is unable to answer the question with a confidence level greater than the defined confidence threshold level, sending, by the computer, the question to a text classifier of the computer.

6. The computer-implemented method of claim 1 further comprising:
receiving, by the computer, from a text classifier, a set of one or more subject matter expert classes having a highest level of confidence scores to correctly answer the question; and
selecting, by the computer, a subject matter expert class with a highest confidence score to correctly answer the question from the set of one or more subject matter expert classes.

7. The computer-implemented method of claim 6, wherein the text classifier calculates a confidence score for each subject matter expert class in the set of one or more subject matter expert classes based on at least one of same questions or similar questions to the question that are associated with each subject matter expert class.

8. The computer-implemented method of claim 1 further comprising:
responsive to the computer removing the selected subject matter expert class from a set of subject matter expert classes, determining, by the computer, whether another subject matter expert class exists in the set of subject matter expert classes; and
responsive to the computer determining that another subject matter class does exist in the set of subject matter expert classes, selecting, by the computer, another subject matter expert class with a next highest confidence score from the set of subject matter expert classes.

9. The computer-implemented method of claim 1, wherein a name of the subject matter expert identifies the selected subject matter expert class.

10. The computer-implemented method of claim 1, wherein a text classifier associates questions that the subject matter expert is able to answer with a class corresponding to the subject matter expert.

11. A computer system for managing questions, the computer system comprising:
a bus system;
a storage device connected to the bus system, wherein the storage device stores program instructions; and
a processor connected to the bus system, wherein the processor executes the program instructions to:
send a question to a subject matter expert corresponding to a selected subject matter expert class via a network;
receive a response from the subject matter expert via the network indicating whether the subject matter expert is able to answer the question;
determine whether the response indicates that the subject matter expert is able to answer the question; and
transform a state of a data structure corresponding to the selected subject matter expert class by adding text of the question to the selected subject matter expert class in response to determining that the response does indicate that the subject matter expert is able to answer the question.

12. The computer system of claim 11, wherein the processor further executes the program instructions to:
remove the selected subject matter expert class from a set of subject matter expert classes in response to determining that the response indicates that the subject matter expert is unable to answer the question.

13. A computer program product for managing questions, the computer program product comprising a computer readable storage medium having program instructions embodied therewith, the program instructions executable by a computer to cause the computer to perform a method comprising:
sending, by the computer, a question to a subject matter expert corresponding to a selected subject matter expert class via a network;
receiving, by the computer, a response from the subject matter expert via the network indicating whether the subject matter expert is able to answer the question;
determining, by the computer, whether the response indicates that the subject matter expert is able to answer the question; and
responsive to the computer determining that the response does indicate that the subject matter expert is able to answer the question, transforming, by the computer, a state of a data structure corresponding to the selected subject matter expert class by adding text of the question to the selected subject matter expert class.

14. The computer program product of claim 13 further comprising:
responsive to the computer determining that the response indicates that the subject matter expert is unable to answer the question, removing, by the computer, the selected subject matter expert class from a set of subject matter expert classes.

15. The computer program product of claim 13 further comprising:
receiving, by the computer, the question from a data processing system corresponding to a user via the network;
sending, by the computer, the question to an expert system of the computer;
determining, by the computer, whether the expert system is able to answer the question with a confidence level greater than a defined confidence threshold level; and
responsive to the computer determining that the expert system is able to answer the question with a confidence level greater than the defined confidence threshold level, sending, by the computer, the answer to the question to the data processing system corresponding to the user via the network and receiving, by the computer, a response from the data processing system corresponding to the user via the network indicating whether the answer to the question is acceptable to the user.

16. The computer program product of claim 15 further comprising:
responsive to the computer determining that the response indicates that the answer is unacceptable, sending, by the computer, the question to a text classifier of the computer.

17. The computer program product of claim 15 further comprising:
responsive to the computer determining that the expert system is unable to answer the question with a confidence level greater than the defined confidence threshold level, sending, by the computer, the question to a text classifier of the computer.

18. The computer program product of claim 13 further comprising:
receiving, by the computer, from a text classifier, a set of one or more subject matter expert classes having a highest level of confidence scores to correctly answer the question; and
selecting, by the computer, a subject matter expert class with a highest confidence score to correctly answer the question from the set of one or more subject matter expert classes.

19. The computer program product of claim 18, wherein the text classifier calculates a confidence score for each subject matter expert class in the set of one or more subject matter expert classes based on at least one of same questions or similar questions to the question that are associated with each subject matter expert class.

20. The computer program product of claim 13 further comprising:
responsive to the computer removing the selected subject matter expert class from a set of subject matter expert classes, determining, by the computer, whether another subject matter expert class exists in the set of subject matter expert classes; and
responsive to the computer determining that another subject matter class does exist in the set of subject matter expert classes, selecting, by the computer, another subject matter expert class with a next highest confidence score from the set of subject matter expert classes.
